(19) United States
(12) Patent Application Publication
(10) Pub. No.: US 2009/0145902 A1
(43) Pub. Date: Jun. 11, 2009

(54) TAMPER-PROOF CLOSURE FOR A TUBE

(75) Inventors: Rainer Krallmann, Hiddenhausen (DE); Oliver Holl, Langenfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Karl Holl GmbH & Co. KG, Langenfeld (DE)

(21) Appl. No.: 12/269,395

(22) Filed: Nov. 12, 2008

(30) Foreign Application Priority Data
Nov. 16, 2007 (DE) 10 2007 055 048.2

(51) Int. Cl. B65D 17/34; B29C 69/02

(52) U.S. Cl. 220/270; 264/241

(57) ABSTRACT

A tamper-proof closure for a tube includes a tab which is placed at a distance to an end face of a neck of a tube. Connected to the neck by a perforate line is a membrane for sealing a discharge bore of the neck. The membrane has a neck-distal side which is formed in one piece with a ring defined by an outer diameter which is smaller than an inner diameter of the neck. The tab is connected to the membrane by a hinge by which the tab can be pulled upwards to allow the membrane to be yanked out from the neck by a user.

### CROSS-REFERENCES TO RELATED APPLICATIONS

This application claims the priority of German Patent Application, Serial No. 10 2007 055 048.2, filed Nov. 16, 2007, pursuant to 35 U.S.C. 119(a)-(d), the content of which is incorporated herein by reference in its entirety as if fully set forth herein.

### BACKGROUND OF THE INVENTION

The present invention relates to a tamper-proof closure for a tube, and to a method of making a tamper-proof closure for a tube.

Nothing in the following discussion of the state of the art is to be construed as an admission of prior art.

A tamper-proof closure is oftentimes realized by sealing a discharge bore of the neck of a tube by a membrane. To open the neck, the cap of the tube has a piercing piece on the outside by which the membrane can be pierced when attaching the cap in reverse to the tube.

U.S. Pat. No. 5,255,804 describes a tamperproof closure for a tube, including a neck projection on a neck of the tube, which neck projection is riveted to an edge of a sleeve section provided in a cap. After the neck projection has been broken off to use the tube, the cap can be replaced on the tube, however, the connection is so loose that when the tube is picked up again, the cap is immediately detached from the neck, thus indicating prior use.

German utility model no. DE 20 2007 000 395 describes a tamper-proof closure for sealing the neck of a tube or bottle, including a straight, curved or slanted tab which is connected to a membrane via a hinge, with the membrane connected to the neck via a thin-walled perforate line for hermetically sealing the neck to the outside. The perforate line is hereby slightly thinner than the membrane. The tab can be folded out to allow removal of the membrane from the neck by pulling on the tab. In addition to the hinge, the tab is also connected by thin bridges with the membrane to secure the tab in place and center it, when a cap is attached to the tube.

It would be desirable and advantageous to provide an improved tamper-proof closure to obviate prior art shortcomings.

### SUMMARY OF THE INVENTION

According to one aspect of the present invention, a tamper-proof closure for a tube includes a tab placed at a distance to an end face of a neck of a tube, a membrane, connected to the neck by a perforate line, for sealing a discharge bore of the neck, with the membrane having a neck-distal side formed in one piece with a ring which is defined by an outer diameter which is smaller than an inner diameter of the neck, and a hinge connecting the tab to the membrane and constructed to remove the membrane from the neck by a user.

According to another feature of the present invention, the hinge may include a reinforcement sized to extend to a midsection of the membrane. The membrane may have a thickness of 0.9 mm, and the perforate line may have a thickness of 0.2 mm.

According to another feature of the present invention, the tab may extend at an angle of about 5° to 10° in relation to a principal axis of the tube.

According to another aspect of the present invention, a method of making a tamper-proof closure for a tube includes the steps of producing a tab and membrane combination interconnected by a hinge, and molding the membrane onto a neck of a tubular member such that a point of injection is situated in midsection of a neck-distal side of the membrane.

The present invention resolves prior art problems by disposing the injection point for the membrane in the neck of a tubular member, such as a tube, tube shoulder, separate threaded sleeve, or bottle, in midsection of a neck-distal side. This is an important feature because it is difficult to fill a tool precisely and symmetrically across the thin-walled perforate line with plasticized material.

According to another feature of the present invention, the injection point may be situated laterally on the tab or on the hinge or the reinforcement thereof.

According to another feature of the present invention, the tab may extend at an angle of about 5° to 10° in relation to a principal axis of the tubular member, when the tab and membrane combination is connected to the neck, wherein the tab is urged into a substantial vertical relationship to the principal axis, when a cap is attached to the neck.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a tube shoulder having incorporated the subject matter according to the present invention;

FIG. 2 is a side view of the tube shoulder of FIG. 1;

FIG. 3 is a section view of the tube shoulder of FIG. 1, taken along the line III-III in FIG. 2;

FIG. 4 is a detailed illustration of combined tab and membrane assembly for providing a tamper-proof closure of the tube shoulder;

FIG. 5 is a perspective view of the tube shoulder, with the tab being pulled upwards;

FIG. 6 is a perspective view of another embodiment of a tube shoulder having incorporated the subject matter according to the present invention;

FIG. 7 is a side view of the tube shoulder of FIG. 6;

FIG. 8 is a section view of the tube shoulder of FIG. 6, taken along the line VIII-VIII in FIG. 7;

FIG. 9 is a perspective view of a threaded sleeve having incorporated the subject matter according to the present invention;

FIG. 10 is a side view of the threaded sleeve of FIG. 9;

FIG. 11 is a section view of the threaded sleeve of FIG. 9, taken along the line XI-XI in FIG. 10;

FIG. 12 is a section view of the tube shoulder of FIG. 1 with attached tab and membrane assembly and cap; and

FIG. 13 is a section view of the tube shoulder of FIG. 12 with removed tab and membrane assembly and attached cap.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

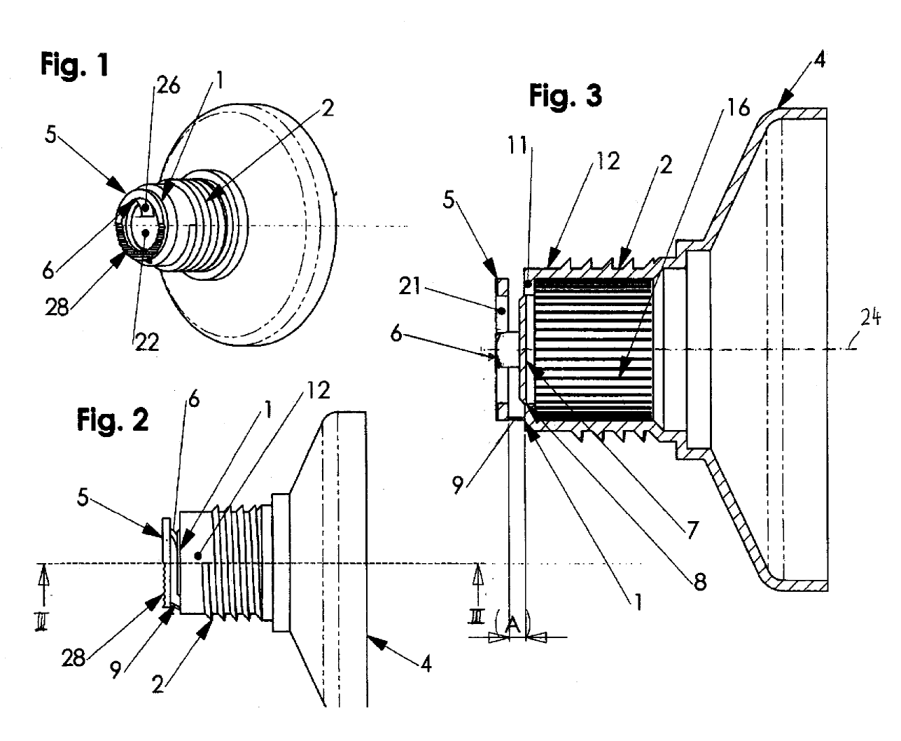

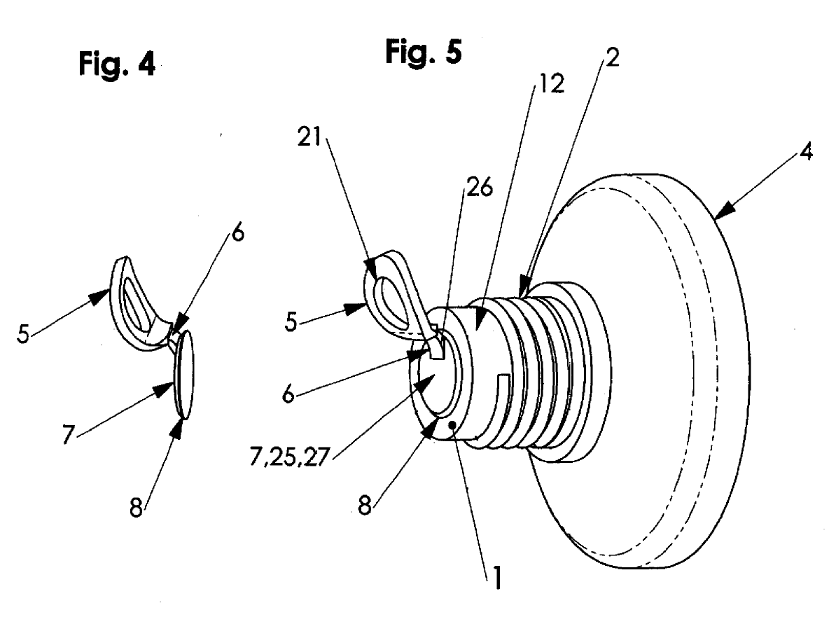

Turning now to the drawing, and in particular to FIG. 1, there is shown a perspective view of an exemplary tube shoulder, generally designated by reference numeral 4, for attachment to an aluminum tube. It is to be understood by persons skilled in the art that the term “tube shoulder” is used here in a generic sense and the principles described in the following description with respect to the tube shoulder are equally applicable to any other type of tubular member which generally follows the concepts outlined here, such as, e.g. a tube, e.g. of aluminum or plastic, threaded sleeve, or bottle.

The tube shoulder 4 has a neck 2, which is shaped to form an inner stop 11, and a disk-shaped membrane 7 which forms a tamper-proof closure or seal of originality and seals a discharge bore 22 of the neck 2. The stop 11 provides a precise securement of the tube shoulder 4 upon the aluminum tube. The membrane 7 has a thickness of about 0.9 mm and has an outer perforate line 8 of about 0.2 mm for connection to the neck 2. A tab 5 is connected to the membrane 7 via a hinge, generally designated by reference numeral 6 and provided with a reinforcement 26. The tab 5 extends in parallel relationship to an end surface 1 of the neck 2 of the tube shoulder 4 at a distance A and is molded onto the membrane 7 via a thin bridge 9 which is arranged in 180° offset relationship to the hinge 6 for stabilizing the tab 5 in relation to the end surface 1. The tube shoulder 4 is further provided on the inside thereof with a fluting 16 for engagement in a complementary fluting of the aluminum tube so as to secure the neck against rotation.

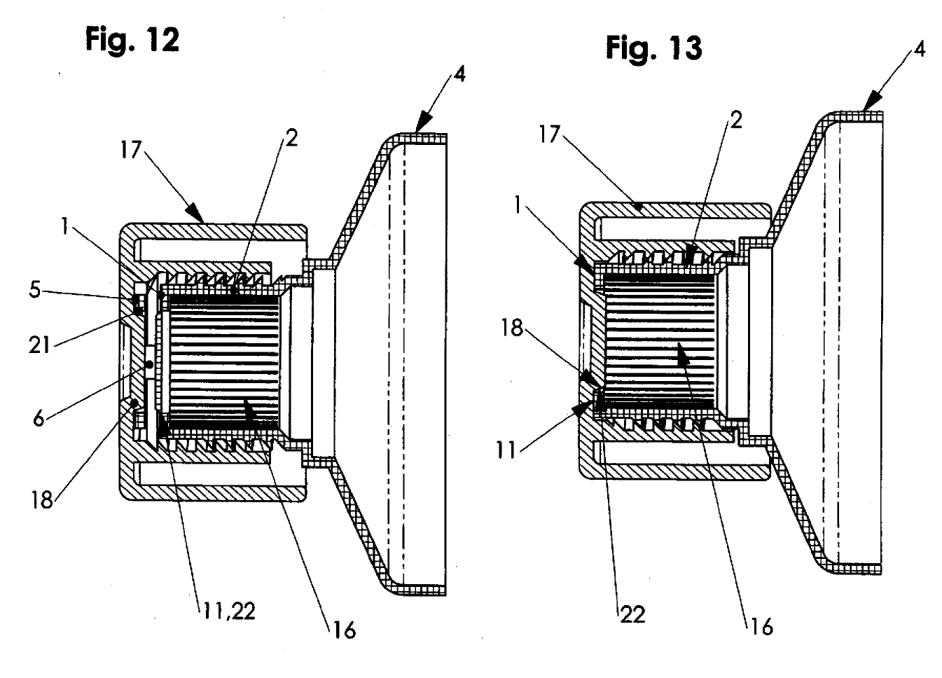

The neck 2 has an outer thread 12 for attachment of a cap 17 (FIG. 12) which is formed with a recessed member 18. The tab 5 is provided with an opening 21 to receive the recessed member 18, when the cap 17 is screwed on, as shown in FIG. 12, and to allow a user a better grip when the tube is to be opened by pulling up the tab 5 and forcing the membrane 7 out of the neck 2. Once the combined tab and membrane assembly 5, 6, 7 is yanked out, the cap 17 is screwed onto the outer thread 12 in order to close the tube, as shown in FIG. 13, with the recessed member 18 received in the opening defined by the stop 11 to realize an airtight seal. Suitably, the tab 5 is formed on the outside with a grip element 28 in the form of a fluting in opposition to the hinge 6 to enhance the gripping capability.

FIG. 4 shows a detailed illustration of combined tab and membrane assembly 5, 6, 7 after removal thereof from the neck 2. The tab 5 is still connected to the membrane 7 by the hinge 6, and the remainder of the perforate line 8 can also be seen. FIG. 5 shows the combined tab and membrane assembly 5, 6, 7 still received in the neck 2 but with the tab 5 being pulled upwards for subsequent removal of the membrane 7 from the discharge bore 22 of the neck 2. The tab 5 can then be pulled to yank out the membrane 7. The reinforcement 26 of the hinge 6 ensures hereby that the tab 5 does not detach from the membrane 7.

As indicated in FIG. 5 by reference numeral 27, the point of injection of material by an unillustrated tool, such as a nozzle, for attachment of the membrane 7 within the neck 2 is arranged in midsection or center 25 of the neck-distal side of the membrane 7. The injection point(s) may also be arranged on the tab 5 or on the hinge 6 or the reinforcement 26 thereof. As the membrane 7 is very thin compared to the tube shoulder 4 and the thread turns, i.e. the membrane 7 requires little material for its realization, the nozzle, which has a diameter in the range of tenths of millimeter, is placed against the tube shoulder 4 in midsection of the tube shoulder 4, i.e. substantially coincident with the principal axis 24 of the tube shoulder 4, or slightly offset thereto. Material, such as plastic material, injected by the nozzle at the injection point 27 cools down quickly so that the material is injected under substantial pressure.

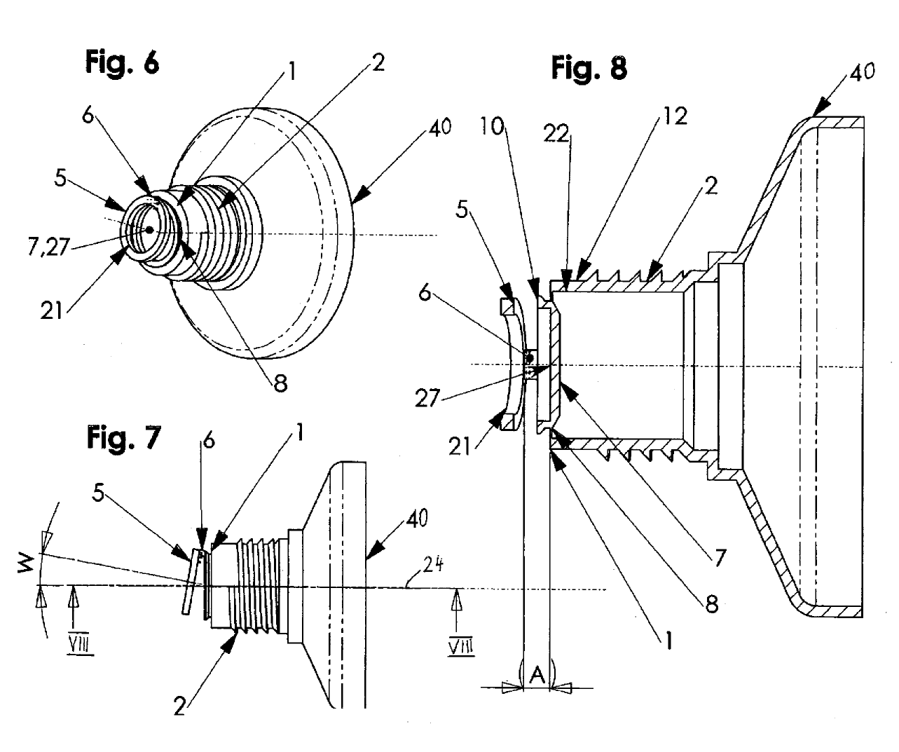

Referring now to FIG. 6, there is shown a perspective view of another embodiment of a tube shoulder, generally designated by reference numeral 40. Parts corresponding with those in FIG. 1 are denoted by identical reference numerals and not explained again. The description below will center on the differences between the embodiments. In this embodiment, the neck 2 is devoid of an inner stop 11, and the tab 5 extends at an angle W (FIG. 7) of about 10° in relation to the principal axis 24 of the tube shoulder. The tab 5 is injection-molded in this angled disposition to the tube shoulder 40. When the cap 17 is screwed onto the external tread 12 of the neck 2, the tab 5 is forced into a position parallel to the end surface 1. As a result, when the cap 17 is removed, the tab 5 is returned spontaneously to its angled disposition to allow a user to easily grip the tab 5 and pull it up and outwards to yank out the membrane 7. This type of tube shoulder 4 forms a basis for a laminated plastic tube.

As shown in particular in FIG. 8, which is a section view of the tube shoulder of FIG. 6, taken along the line VIII-VIII in FIG. 7, the membrane 8 is formed in one piece with a ring 10 defined by an outer diameter which is smaller than an inside diameter of the neck 2.

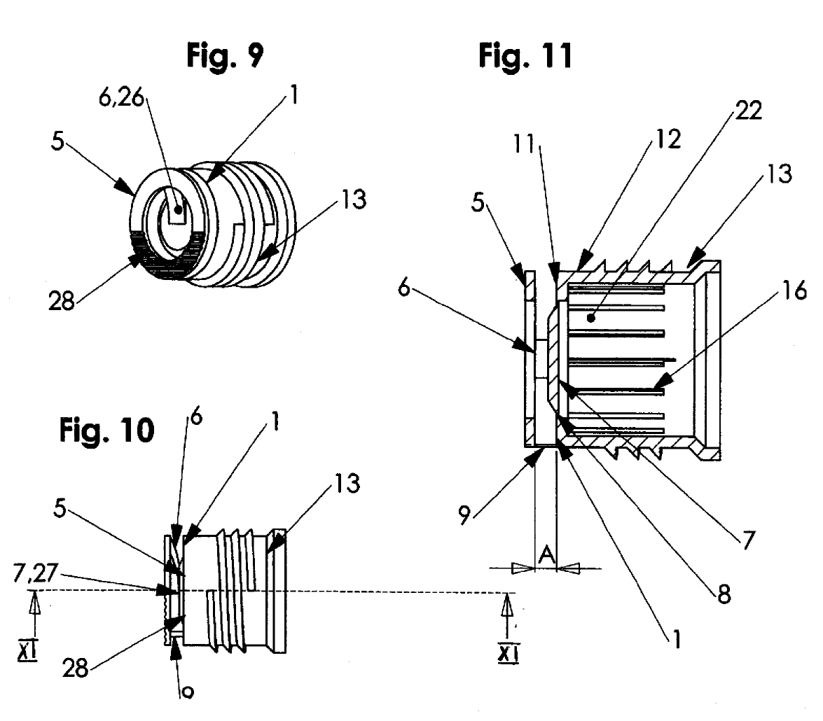

Referring now to FIG. 9, there is shown a perspective view of a threaded sleeve, as a further example of a tubular member, generally designated by reference numeral 13. Parts corresponding with those in FIG. 1 are denoted by identical reference numerals and not explained again. The threaded sleeve 13 has grooves 16 for engagement with inner keys of the neck 2 of an aluminum tube so as to be constraint against rotation, and is secured in place by the stop 11. The tab and membrane assembly 5, 6, 7 is constructed in a same way as described above, so that through upward and outward pulling of the tab 5, the membrane 7 can be yanked out of the discharge bore 22 of the threaded sleeve 13.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A tamper-proof closure for a tube, comprising:
a tab placed at a distance to an end face of a neck of a tube;
a membrane, connected to the neck by a perforate line, for sealing a discharge bore of the neck, said membrane having a neck-distal side formed in one piece with a ring which is defined by an outer diameter which is smaller than an inner diameter of the neck; and
a hinge connecting the tab to the membrane and constructed to remove the membrane from the neck by a user.

2. The closure of claim 1, wherein the hinge includes a reinforcement sized to extend to a midsection of the membrane.

3. The closure of claim 1, wherein the membrane has a thickness of 0.9 mm.

4. The closure of claim 1, wherein the perforate line has a thickness of 0.2 mm.

5. The closure of claim 1, wherein the tab extends at an angle of about 5° to 10° in relation to a principal axis of the tube.

6. A method of making a tamper-proof closure for a tube, comprising the steps of:
producing a tab and membrane combination interconnected by a hinge; and
molding the membrane onto a neck of a tubular member such that a point of injection is situated in midsection of a neck-distal side of the membrane.

7. The method of claim 6, wherein the tubular member is an element selected from the group consisting of tube, tube shoulder, threaded sleeve, and bottle.

8. The method of claim 6, wherein the injection point is situated on the tab.

9. The method of claim 6, wherein the injection point is situated on the hinge.

10. The method of claim 6, wherein the tab extends at an angle of about 5° to 10° in relation to a principal axis of the tubular member, when the tab and membrane combination is connected to the neck, further comprising the step of attaching a cap to the neck to thereby urge the tab into a substantial vertical relationship to the principal axis.
